(19) United States
(12) Patent Application Publication
(10) Pub. No.: US 2020/0113788 A1
(43) Pub. Date: Apr. 16, 2020

(54) Baby bottle top with liquid level detection

(71) Applicant: SLOW CONTROL, saint paul - Reunion (FR)

(72) Inventor: Jacques LEPINE, L'isle Adam (FR)

(21) Appl. No.: 16/501,544

(22) PCT Filed: Oct. 3, 2017
(86) PCT No.: PCT/FR2017/000183

§ 371 Date: Apr. 30, 2019

(30) Foreign Application Priority Data
Oct. 4, 2016 (FR) 1670580
Dec. 21, 2016 (FR) 1670775

(51) Int. Cl. A61J 9/06; G01F 25/00

(52) U.S. Cl. CPC A61J 9/06; A61J 2200/76; G01F 25/0061

(57) ABSTRACT

Milk feeding bottle covering comprising a base which houses an electronic circuit comprising calculation means, power supply means, an inclinometer, transmitting-receiving means for communicating with a remote terminal, characterized in that it comprises a garland (G) diodes (61) light emitting, towards a light sensor (71), on the opposite side of the bottle, the garland emits light trains which successively turn on and off the dies of the garland one by one, the electronic card which controls the lighting of the light trains is also connected to the light sensor (71), the light sensor detects light intensity jumps when the light train is no longer masked by the milk to deduce the level of milk in the bottle, the computing means couples the level information to that of angle bottle holding and deduce a recommendation that is addressed to the user.

The present invention relates to an intelligent detachable overcap for real-time baby bottle-feeding monitoring.

The invention aims to improve a performance of baby bottles which is that of the good flow of liquid for the baby. Indeed, baby bottles have defects in the quality of the flow delivered to the baby. A first fault is that sometimes the nipples are clogged. These are often lumps that come to block the flow. A second fault is that it happens to the baby to suck air. This happens especially when the bottle is insufficiently tilted compared to the level of liquid level in the bottle.

A main object of the invention is therefore to check the quality of the flow of the bottle and warn the parent if the bottle is either clogged or mis-oriented.

Another object of the invention is to give an overview of the baby's eating history.

Another object of the invention is to provide the parent with a tool for monitoring the baby's food intake.

Another object of the invention is to provide an alarm tool to the parent to warn if the catch is insufficient or too slow or too fast.

Another object of the invention is to warn the parent if the bottle is properly inclined given the level of liquid present in the bottle. Indeed for the same level of liquid in a bottle, if the bottle is insufficiently inclined, then the nipple offers air to drink to the baby, which is not good and especially a risk factor for violent bowel pains named colics. If the bottle is too inclined, this is also bad because then the flow of liquid flowing from the nipple is under potentially too great weight. There is a risk of regurgitation or choking with too much fluid entering the baby's mouth.

An object of the invention is therefore to give the parent a feedback which indicates him the level of liquid in the bottle, if it is correctly inclined, namely in an acceptable range around the ideal inclination.

In one main aspect, the invention proposes to give the weight in the bottle by measuring through a system of optical sensors located in a plane passing through the bottle, then coupling this data to that of another sensor which is an angular sensor, comparing these data with those of a table of pre-established data, to finally deduce the level of liquid in the bottle

In one aspect, the invention provides an intelligent bottle cap that captures the rate of bottle feeding.

In one aspect, the invention provides a bottle cap that captures the weight of liquid in the bottle.

In one aspect, the invention provides a bottle cap that captures the history of taking meals.

In one aspect the invention provides a bottle cap that captures the baby's feeding efforts.

In one aspect, the invention provides a bottle cap that captures the angle of the bottle relative to the vertical and the flow of liquid and or air in the nipple.

In one aspect, the invention provides a bottle cap that captures if the baby is drinking air.

In one aspect, the bottle cap takes the form of a clip. Indeed the set of sensors according to a variant is disposed in a plane perpendicular to that of the clip.

In one aspect the invention remounts all the data captured and transmits wired or wireless link to a remote terminal as a smart phone.

The appended figures represent a particular embodiment of the invention in which:

FIG. 1 shows a traditional bottle in vertical

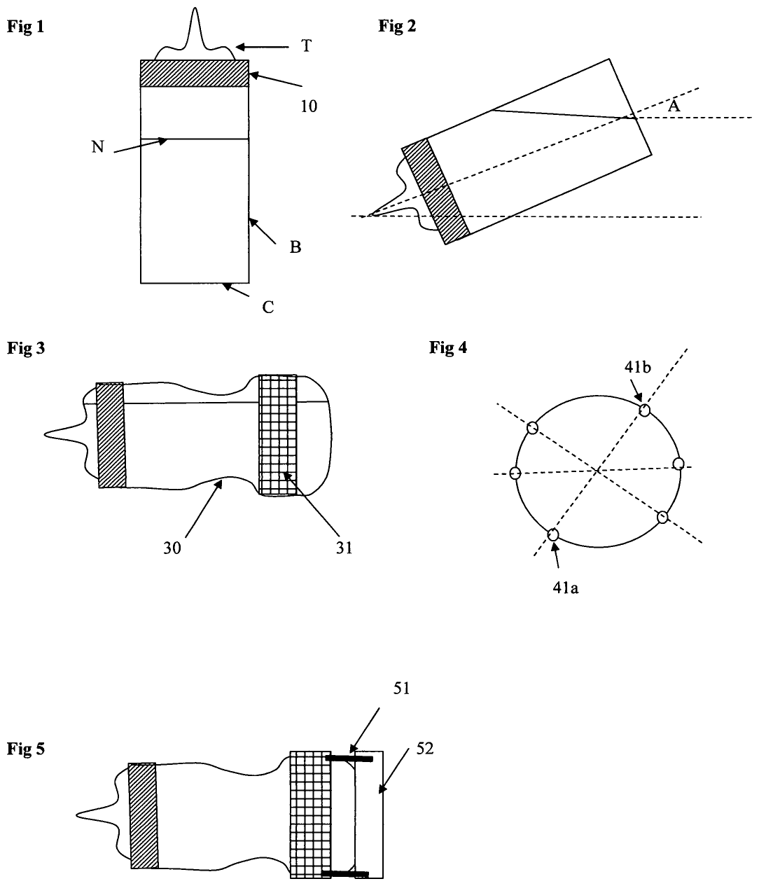

FIG. 2 shows a traditional leaning baby bottle that delivers milk

FIG. 3 represents a bottle equipped with a level measure device according to the invention

FIG. 4 represents a basic section of the level measure according to the invention

FIG. 5 shows the complete invention with the level measure coupled with its intelligent base.

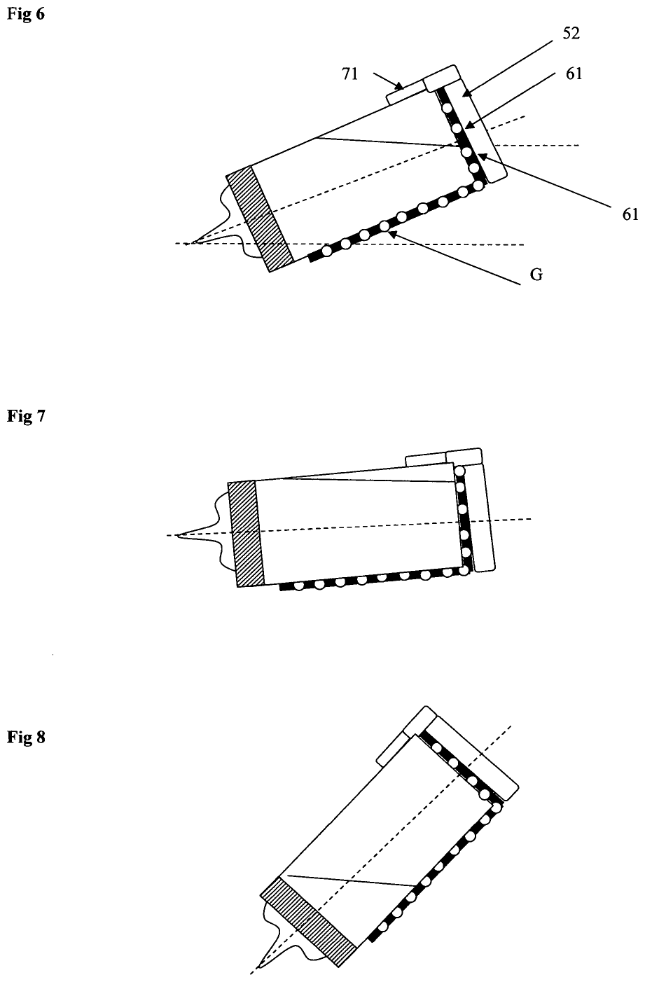

FIG. 6, 7, 8 show a variant of the invention called string garland that validates the liquid level in three different holding angles.

FIG. 1 shows a traditional bottle in vertical, with its bottle (B), the bottom of its bottle (C) its nipple screwing ring (10), its nipple (T). The nipple screw ring has a side face that matches the side wall of the bottle and an upper face that partially closes the bottle. A hole is disposed on the upper face of the screw ring to pass the nipple through which will suck the baby. FIG. 2 shows a traditional tipped bottle that delivers milk. In this figure, the liquid reaches the nipple and the baby can drink. The angle (A) that the bottle makes with the horizontal is such that the liquid reaches the nipple. For the same level of liquid, if this angle (A) decreases too much, the bottle ends up being in a position where it gives air. FIG. 3 shows a feeding bottle equipped with a level ring (31) according to the invention, which is mounted at the bottom of the bottle and which circles the bottle with a maintenance and friction or holding forces designed for this ring holds an almost fixed position on the wall of the bottle. In certain variants to ensure optimum support, the level measuring ring (31) can be supported on the cutting edges (30) of bottle which often have recesses and/or bosses that are thought by the bottle manufacturers to aesthetic and/or ergonomic reasons. FIG. 4 represents a basic section of the level ring according to the invention which has arranged on a circle facing the pairs of optical sensors. Namely, for example, photoluminescent diodes placed vis-a-vis photo resistors. By placing a series of pairs of optical detectors in a series of angles and coupling it with algorithmic processing, it becomes possible to determine the level of liquid in the bottle. The particularity of the invention is that the optical detectors are preferably placed in a plane perpendicular to that of the axis of the bottle. Preferably on a ring to fit the shape of the bottle and can more easily calculate the liquid level regardless of the angular inclination of the bottle along its main axis and also with respect to the ring. Indeed, in another form of solution, by placing the pairs of diodes vis-à-vis two parallel planes that frame the bottle, it then becomes necessary to couple the processing of the level measurement to that of the angle ground planes to calculate the actual level of fluid in the bottle. It is also quite obvious that the calculation of liquid level gives an efficient representation in a precision of one gram of the amount of liquid in the bottle given the average density of milk given to the baby. In all cases, the essential feature of the invention is to compare one by one the measurements from a plurality of sensors to infer by calculation a level information which can then be retranscribed by weight of liquid in the bottle and/or in risk analysis for the liquid pressure at the end of the nipple depending on the angle at which the bottle is held.

FIG. 5 shows the complete invention with the level measuring ring (31) coupled to a base (52). The base (52) includes a weight sensor that may be in some bidirectional variants in the direction of the main axis of the bottle. This sensor thus makes it possible to detect the weight of the bottle when it is vertical placed on its base, and the longitudinal head forces when the baby head the bottle and therefore applies a force on the nipple. The base also includes an inclinometer. Commonly, the inclinometer is an accelerometer that takes into account the low acceleration of the bottle when used so determines its angle with the vertical. The base also obviously includes an electronic circuit with calculation means, power supply means, transmitter and receiver means for communicating with a remote terminal. The ring is connected to the base (50) by supports (51) rigid. The challenge is that double 1—that the inclinometer in the base gives an accurate measurement of the angle of the bottle 2—that the weight of the bottle is well on the base of the bottle. Depending on the ergonomic choices, it may then be chosen that the level ring is held firmly against the bottle and transmits its weight on the base or in an equivalent variant, that the level ring floats around the bottle but that the bottle is well maintained by a lateral outer shell shape in very small translational fringes so that 1—for well-understood reasons of level calculation accuracy, the level ring is positioned in a precise area around the bottle 2—that the weight effort that applies is not truncated by the holding of the hand on the bottle that could hold the ring. The holders (51) between the level ring (31) and the base (50) are therefore sliding in the case of a ring held firmly against the bottle or firm in the case of a sliding ring around the bottle. Everything is a matter of choice of ergonomics and aesthetics and both variants are possible.

FIG. 6 shows a particular arrangement of diode and sensor which optimizes both the information taking and the cost price of the product. The solution lies in a garland (G) of diodes (61), the garland is held in a plane that contains the main axis of the bottle, from the top of the bottle just under the nipple ring and down, along the main axis bottle against the side wall, then comes to marry the bottom of the bottle. In front of the garland (G), on the bottom of the bottle, towards the corner, near the bottom of the bottle is arranged a light sensor (71). The garland emits light trains that turn on and off successively one by one the diodes of the garland. The electronic board which controls the lighting of the light trains is also connected to the light sensor (71). The light sensor detects light intensity jumps when the light train is no longer masked by the opaque liquid that is the milk in the bottle. In short, when the light emitted by the light train is masked by the milk, the light intensity received is that of the ambient light. When the light emitted by the light train is no longer masked by the milk, the light intensity received by the light sensor is that of the ambient light plus that of the emitting diode of the light train. If the diodes emit sufficient light and/or if the ambient light is sufficiently masked by a masking sock which confines the emitting diodes—light sensor couples, then the system is able to detect the liquid level and detecting the diode for which the light sensor detects a received light intensity jump. This solution, unlike that of FIG. 5, has the dual interest 1—to adapt to all conditions of bottle filling, bottle full FIG. 7, almost empty bottle FIG. 8, half-full bottle FIGS. 6, and 2 By increasing the number of diodes and decreasing the number of sensors, the sensors being more expensive than the diodes, for the same number of possible measurements, the cost price is therefore reduced.

It is understood that the overcap can also be a clip, a sock and that we can name it bottle dressing.

The present invention thus relates to a milk bottle cover comprising a base which houses an electronic circuit comprising calculating means, power supply means, an inclinometer, transmitting/receiving means for communicating with a remote terminal, characterized in that it comprises a garland (G) of diodes (61) emitting light, the garland is held in a plane that contains the main axis of the bottle, from the top of the bottle just under the pacifier ring and goes down, according to the main axis of the bottle against the side wall, then comes to marry the bottom of the bottle, vis-à-vis the garland (G), on the bottom of the bottle, to the corner, near the bottom of the bottle is arranged a sensor light (71), the garland emits light trains which turn on and off successively one by one the diodes of the garland, the electronic card which controls the lighting of the light trains is connected ega light sensor (71), the light sensor detects light intensity jumps when the light train is no longer masked by the milk to deduce the level of milk in the bottle, the calculation means couple level information to that bottle holding angle and deduce a recommendation that is addressed to the user.

Of course, in a vertical position, in a calibration phase, the data from the inclined optical sensors can be compared to that of the weight sensor data for calibration of the entire user feedback.

The invention is also capable of determining the history of taking meals: meal time, total intake, flow during the meal.

It is thus well understood that many variants of the invention may fall within the scope of the present invention.

1. Milk feeding bottle covering comprising a base which houses an electronic circuit comprising calculation means, power supply means, an inclinometer, transmitting-receiving means for communicating with a remote terminal, characterized in that it comprises a garland (G) diodes (61) light emitting, towards a light sensor (71) positionned on the opposite side of the bottle, the garland emits light trains which successively turn on and off the dies of the garland one by one, the electronic card which controls the lighting of the light trains is also connected to the light sensor (71), the light sensor detects light intensity jumps when the light train is no longer masked by the milk to deduce the level of milk in the bottle, the computing means couples the level information to that of angle bottle holding and deduce a recommendation that is addressed to the user.

2. Millk feeding bottle covering according to claim 1 characterized in that the garland is held in a plane that contains the main axis of the bottle, from the top of the bottle just under the pacifier ring and down, along the main axis of the bottle against the side wall, then comes to marry the bottom of the bottle, vis-à-vis the garland (G), on the bottom of the bottle, to the corner, near the bottom of the bottle is positionned the ligt sensor (71).
